(19) United States
(12) Patent Application Publication
(10) Pub. No.: US 2010/0102873 A1
(43) Pub. Date: Apr. 29, 2010

(54) Output Driving Circuit for an Ethernet Transceiver

(76) Inventor: Chen-Yu Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/257,379

(22) Filed: Oct. 23, 2008

(51) Int. Cl. G05F 3/02

(52) U.S. Cl. 327/538

(57) ABSTRACT

An output driving circuit for an Ethernet transceiver is utilized for driving a load, which includes a first loading end and a second loading end. The output driving circuit includes a voltage output driver, a first resistor, a second resistor, a first current source, a second current source, a third current source and a fourth current source. The voltage output driver is utilized for providing an output voltage. The first resistor and the second resistor are utilized for modifying impedance matching with the load. When the output voltage is positive, the first current source and the second current source are turned-on, and the third current source and the fourth current source are turned-off. Whereas when the output voltage is negative, the first current source and the second current source are turned-off, and the third current source and the fourth current source are turned-on.

### BACKGROUND OF THE INVENTION

1. Field of the Invention

The present invention relates to an output driving circuit for an Ethernet transceiver, and more particularly, to an output driving circuit for reducing power consumption and optimizing the output driving circuit.

2. Description of the Prior Art

The wired Internet generally utilizes the RJ-45 twisted pair to transmit signals, and the twisted pair standards include 10 Base-T, 100 Base-T and 1000 Base-T with transmission speed of 10 Mb/s, 100 Mb/s and 1 Gb/s respectively. In order to conform to the three standards, designs of an output driving circuit for an Ethernet transceiver become more difficult.

Please refer to FIG. 1, which is a schematic diagram of an output driving circuit 10 for an Ethernet transceiver in the prior art. The output driving circuit 10 comprises a common mode voltage driver 102, resistors 104, 106 with the same resistance, a first current source 108, a second current source 110, a third current source 112, a fourth current source 114, a voltage source VDD and a load R_{L}. The common mode voltage driver 102 is utilized for providing an output voltage V_{OUT}. The first current source 108 and the second current source 110 are utilized for providing a driving current with a value 2 I when the output voltage V_{OUT} is positive. The third current source 112 and the fourth current source 114 are utilized for providing a driving current with a value 2 I when the output voltage V_{OUT} is negative. Half of the driving current flows through the load R_{L}, and another half of the driving current flows through the resistors 104, 106 and the common mode voltage driver 102. Moreover, voltages across the first current source 108, the second current source 110, the third current source 112 and the fourth current source 114 are all V_{dsat}. When the output voltage V_{OUT} is positive, the first current source 108 and the second current source 110 are turned-on, and the third current source 112 and the fourth current source 114 are turned-off. In such a condition, the operational current of the output driving circuit 10 is 21, and the operational voltage thereof is (V_{OUT}+2V_{dsat}). When the output voltage V_{OUT} is negative, the first current source 108 and the second current source 110 are turned-off, and the third current source 112 and the fourth current source 114 are turned-on. In such a condition, the operational current of the output driving circuit 10 is also 21, and the operational voltage thereof is also (V_{OUT}+2V_{dsat}). Therefore, in the two conditions mentioned-above, the operational currents of the output driving circuit 10 are both 21, and the operational voltages thereof are both (V_{OUT}+2V_{dsat}).

Please refer to FIG. 2, which is a schematic diagram of another output driving circuit 20 for an Ethernet transceiver in the prior art. The output driving circuit 20 comprises a voltage output driver 202, resistors 204, 206 with the same resistance and a load R_{L}. Values of the resistors 204, 206 and the load R_{L} shown in FIG. 2 are the same as those of the resistors 104, 106 and the load R_{L} shown in FIG. 1. In FIG. 2, the current flowing through the load R_{L} is I, and the current flowing through the loop can be deduced as I. As a result, the current flowing through the resistors 204, 206 is I, causing a summing voltage across the resistors 204, 206 to be V_{OUT}. In detail, since values of the resistors 204, 206 and the current flowing through the resistors 204, 206 shown in FIG. 2 are the same as those of the resistors 104, 106 and the current flowing through the resistors 104, 106, shown in FIG. 1, the summing voltage across the resistors 204, 206 will be V_{OUT}, which is the summing voltage across the resistors 104, 106. Therefore, in FIG. 2, the voltage output driver 202 needs to provide the summing voltage across the resistors 204, 206, that is V_{OUT}, and the voltage across the load R_{L}, that is V_{OUT}. That totals 2V_{OUT}. Furthermore, adding the device saturation voltage of the voltage output driver 202, 2V_{dsat}, the operational voltage of the output driving circuit 20 is (2V_{OUT}+2V_{dsat}). The operational current of the output driving circuit 20 is I.

In conclusion, the operational current of the output driving circuit 10 shown in FIG. 1 is 21, which consumes too much power. Though the operational current of the output driving circuit 20 shown in FIG. 2 is only I, the operational voltage thereof is (2V_{OUT}+2V_{dsat}), which is more than that of the output driving circuit 10 shown in FIG. 1. Therefore, both the prior arts mentioned-above need to be improved.

### SUMMARY OF THE INVENTION

It is therefore a primary objective of the claimed invention to provide an output driving circuit for an Ethernet transceiver to overcome the drawbacks of the prior art.

The present invention discloses an output driving circuit for an Ethernet transceiver for driving a load. The load comprises a first loading end and a second loading end. The output driving circuit comprises a voltage output driver, a first resistor, a second resistor, a first current source, a second current source, a third current source and a fourth current source.

The voltage output driver is utilized for providing an output voltage, and comprises a first output end and a second output end. The first resistor is coupled between the first output end and the first loading end for modifying impedance matching with the load. The second resistor is coupled between the second output end and the second loading end for modifying impedance matching with the load. The first current source is utilized for providing a first current. One end of the first current source is coupled to a voltage source, and the other end thereof is coupled between the first resistor and the first loading end. The second current source is utilized for providing the first current. One end of the second current source is coupled to a ground, and the other end thereof is coupled between the second resistor and the second loading end. The third current source is utilized for providing a second current. One end of the third current source is coupled to the voltage source, and the other end thereof is coupled between the second resistor and the second loading end. The fourth current source is utilized for providing the second current. One end of the fourth current source is coupled to the ground, and the other end thereof is coupled between the first resistor and the first loading end. When the output voltage is positive, the first current source and the second current source are turned-on, and the third current source and the fourth current source are turned-off, whereas when the output voltage is negative, the first current source and the second current source are turned-off, and the third current source and the fourth current source are turned-on.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an output driving circuit for an Ethernet transceiver in the prior art.

FIG. 2 is a schematic diagram of another output driving circuit for an Ethernet transceiver in the prior art.

FIG. 3 is a schematic diagram of an output driving circuit according to an embodiment of the present invention.

FIG. 4 is a schematic diagram of an implemented circuit of the voltage output driver according to an embodiment of the present invention.

### DETAILED DESCRIPTION

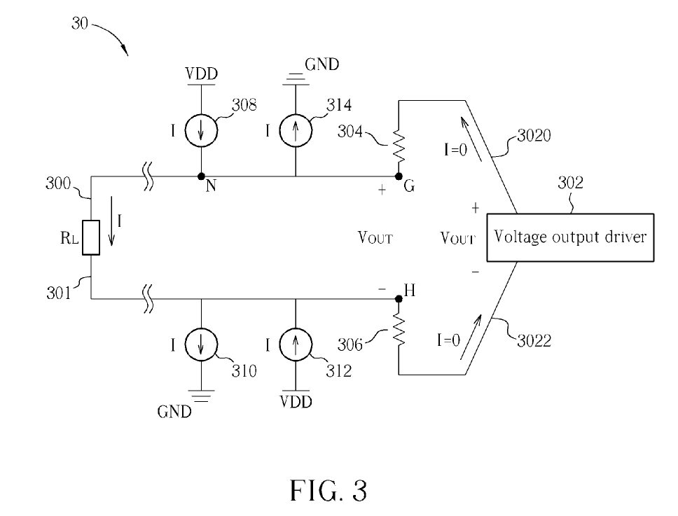

Please refer to FIG. 3, which is a schematic diagram of an output driving circuit 30 according to an embodiment of the present invention. The output driving circuit 30 is applied for an Ethernet transceiver, and is utilized for driving a load R_{L}. The load R_{L} can be a transmission line, and comprises a first loading end 300 and a second loading end 301. The output driving circuit 30 comprises a voltage output driver 302, a first resistor 304, a second resistor 306, a first current source 308, a second current source 310, a third current source 31 2 and a fourth current source 314. The voltage output driver 302 is utilized for providing an output voltage V_{OUT}, and comprises a first output end 3020 and a second output end 3022. The first resistor 304 is coupled between the first output end 3020 and the first loading end 300 for modifying impedance matching with the load R_{L}. The second resistor 306 is coupled between the second output end 3022 and the second loading end 301, and has the same function as the first resistor 304 for modifying impedance matching with the load R_{L}. Preferably, both the first resistor 304 and the second resistor 306 have the same resistance, such as 50 ohms. The first current source 308 is utilized for providing a current with a value I. One end of the first current source 308 is coupled to a voltage source VDD, and the other end thereof is coupled between the first resistor 304 and the first loading end 300. The second current source 310 is also utilized for providing a current with a value I. One end of the second current source 310 is coupled to a ground GND, and the other end thereof is coupled between the second resistor 306 and the second loading end 301. The third current source 312 is utilized for providing a current with a value I. One end of the third current source 312 is coupled to the voltage source VDD, and the other end thereof is coupled between the second resistor 306 and the second loading end 301. The fourth current source 314 is utilized for providing a current with a value I. One end of the fourth current source 314 is coupled to the ground GND, and the other end thereof is coupled between the first resistor 304 and the first loading end 300. Preferably, the first current source 308, the second current source 310, the third current source 312 and the fourth current source 314 are all a current mirror current source. Moreover, when the output voltage V_{OUT} is positive, the first current source 308 and the second current source 310 are turned-on, and the third current source 312 and the fourth current source 314 are turned-off, whereas when the output voltage V_{OUT} is negative, the first current source 308 and the second current source 310 are turned-off, and the third current source 312 and the fourth current source 314 are turned-on. Since operations of the circuit are similar whether the output voltage V_{OUT} is positive or negative, the following descriptions will focus on the condition when the output voltage V_{OUT} is positive, and the condition when the output voltage V_{OUT} is negative can be deduced in the same way by those skilled in the art.

When the output driving circuit 30 is in operation, firstly the current flows from the first current source 308, then through the load R_{L} instead of the route formed by the first resistor 304, the voltage output driver 302 and the second resistor 306, and finally flows through the second current source 310 to the ground GND. This is because resistance of the route formed by the first resistor 304, the voltage output driver 302 and the second resistor 306 is almost infinite, causing the current in a node N to flow through the load R_{L} instead of the route formed by the first resistor 304, the voltage output driver 302 and the second resistor 306. Thus, there is no current flowing through the route formed by the first resistor 304, the voltage output driver 302 and the second resistor 306, and the operational current of the output driving circuit 30 is the current provided by the first current source 308 with the value I.

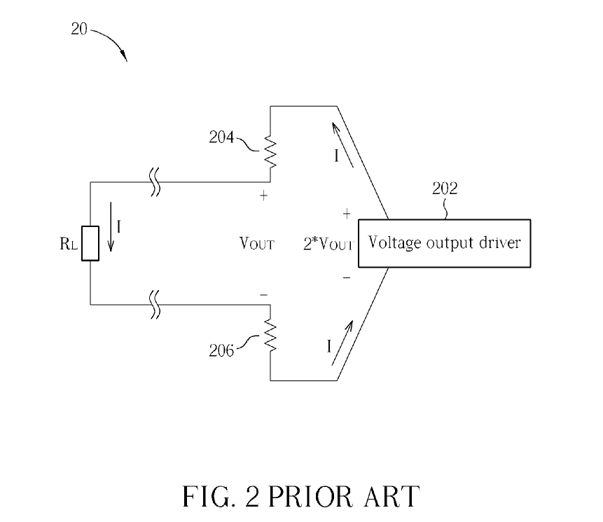

Besides, since there is no current flowing through the route formed by the first resistor 304, the voltage output driver 302 and the second resistor 306, the voltage output driver 302 needs not provide the summing voltage across the resistors provided by the voltage output driver 202 in the prior art shown in FIG. 2. Therefore, the output voltage V_{OUT} provided by the voltage output driver 302 can be applied between nodes G and H directly. Adding the device saturation voltage of the voltage output driver 302, 2V_{dsat}, the operational voltage of the output driving circuit 30 in the present invention is (V_{OUT}+2V_{dsat}).

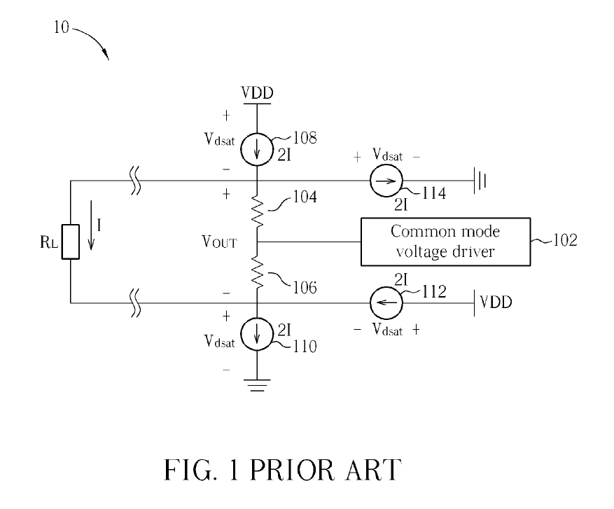

Compared to the prior art shown in FIG. 1, the operational voltage of the present invention, which is (V_{OUT}+2V_{dsat}), is the same as that of the prior art shown in FIG. 1, but the operational current of the present invention, which is I, is less than that of the prior art shown in FIG. 1. Furthermore, compared to the prior art shown in FIG. 2, the operational current of the present invention, which is I, is the same as that of the prior art shown in FIG. 2, but the operational voltage of the present invention, which is (V_{OUT}+2V_{dsat}), is less than that of the prior art shown in FIG. 2. Therefore, the present invention can reduce power consumption and optimize the circuit.

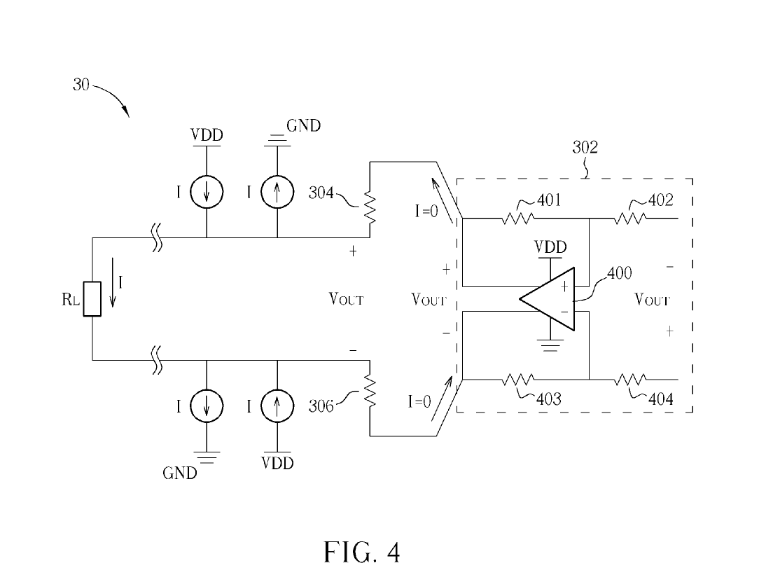

Please note that, the output driving circuit 30 in the present invention can be applied for the Ethernet transceiver which is conformed to the standards of 10 Base-T, 100 Base-T or 1000 Base-T, and is not limited. Moreover, there are many methods to implement the voltage output driver 302. For example, please refer to FIG. 4, which is a schematic diagram of an implemented circuit of the voltage output driver 302 according to an embodiment of the present invention. In FIG. 4, the voltage output driver 302 is composed of an operational amplifier 400 and four resistors 401˜404, and is utilized for providing the output voltage V_{OUT}. Since structures of the voltage output driver 302 shown in FIG. 4 are familiar by those skilled in the art, detailed descriptions are omitted here.

In conclusion, the output driving circuit of the present invention needs less operational current and operational voltage than the prior art, so the present invention can reduce power consumption and optimize the circuit.

Those skilled in the art will readily observe that numerous modifications and alterations of the device and method may be made while retaining the teachings of the invention.

What is claimed is:

1. An output driving circuit for an Ethernet transceiver for driving a load, the load comprising a first loading end and a second loading end, the output driving circuit comprising:
a voltage output driver for providing an output voltage comprising a first output end and a second output end;
a first resistor coupled between the first output end and the first loading end for modifying impedance matching with the load;
a second resistor coupled between the second output end and the second loading end for modifying impedance matching with the load;
a first current source for providing a first current, one end thereof coupled to a voltage source, the other end thereof coupled between the first resistor and the first loading end;
a second current source for providing the first current, one end thereof coupled to a ground, the other end thereof coupled between the second resistor and the second loading end;
a third current source for providing a second current, one end thereof coupled to the voltage source, the other end thereof coupled between the second resistor and the second loading end; and
a fourth current source for providing the second current, one end thereof coupled to the ground, the other end thereof coupled between the first resistor and the first loading end;
wherein when the output voltage is positive, the first current source and the second current source are turned-on, and the third current source and the fourth current source are turned-off, whereas when the output voltage is negative, the first current source and the second current source are turned-off, and the third current source and the fourth current source are turned-on.

2. The output driving circuit of claim 1, wherein a magnitude of the first current is the same as that of the second current.

3. The output driving circuit of claim 2, wherein the Ethernet transceiver is conformed to the standard of 10 Base-T.

4. The output driving circuit of claim 2, wherein the Ethernet transceiver is conformed to the standard of 100 Base-T.

5. The output driving circuit of claim 2, wherein the Ethernet transceiver is conformed to the standard of 1000 Base-T.

6. The output driving circuit of claim 2, wherein the first current source, the second current source, the third current source and the fourth current source are all a current mirror current source.
